(19) United States
(12) Patent Application Publication
(10) Pub. No.: US 2003/0170098 A1
(43) Pub. Date: Sep. 11, 2003

(54) Parts feeding system

(75) Inventors: Richard M. Motley, Orion Township, MI (US); James C. Cooper, Lake Orion, MI (US)

Correspondence Address: DAVID M. LAPRAIRIE, ESQ., HOWARD & HOWARD, 39400 Woodward Avenue, Suite 101, Bloomfield Hills, MI, 48304-5151, US

(73) Assignee: FANUC Robotics North America, Inc.

(21) Appl. No.: 10/091,964

(22) Filed: Mar. 5, 2002

(51) Int. Cl. B65G 65/00

(52) U.S. Cl. 414/416.01

(57) ABSTRACT

A parts feeding system (14) for moving parts (10) relative to a support plane (12) is provided. A robot (16) having a base (18) is disposed on the support plane (12) and operable within an envelope (22) having a limit (24) that extends at an acute angle (B) relative to the support plane (12). First and second part support trays (42,44) are stacked one above the other to support the parts (10) thereon in a stacked position (48). The second part support tray (44) is movable to a stored position (50) which uncovers the first part support tray (42) immediately therebelow. Each of the part support trays (30) includes a front edge (34) facing toward the base (18) in the stacked position (48). The front edge (34) of each of the part support trays (30) is disposed a greater distance from the base (18) than the part support tray (30) therebelow to define a receding stacked relationship.

### FIELD OF THE INVENTION

The present invention relates generally to a parts feeding system for moving parts. More specifically, the present invention relates to a parts feeding system using a robot to move the parts within an envelope of the robot.

### BACKGROUND OF THE INVENTION

Prior art parts feeding systems for moving parts within an envelope of a robot typically include a conveyor belt, a parts hopper for storing parts and feeding the parts to the conveyor belt, a vision device for determining the position of the parts on the conveyor belt, and the robot for moving the parts from the conveyor belt.

Parts are dumped by bulk into the parts hopper where they transcend downward toward the conveyor belt below. The parts are aligned on the conveyor belt one part at a time as the conveyor belt moves below the hopper. The conveyor belt moves each part toward the envelope of the robot. The robot is operable within the envelope and limited in movement to the envelope, i.e., the envelope represents a full range of motion of the robot and hence, the furthest extent in which the robot can reach the parts. Without the conveyor belt, the robot would not be able to reach the parts in the parts hopper. In prior art systems, the parts hopper is not within the envelope of the robot.

The vision device scans each of the parts on the conveyor belt as the parts move toward the envelope. The vision device thereby determines the part's position and relays a signal corresponding to that position to a robot control system. The robot control system then sends a motion signal to the robot thereby relaying the position of the parts to the robot. In response, the robot grabs the part when the part is within the envelope. The robot moves the part from the conveyor belt in the envelope to a workspace in the envelope. Typically, the workspace is defined as the location of a process that manipulates the part such as grinding, welding, and the like.

The systems of the prior art place excessive stress on the conveyor belt and the parts being moved to the envelope. The action of dumping the parts by bulk into the parts hopper is a significant source of stress on the parts and the conveyor belt. As a result, costly, reinforced structures are needed to support such parts feeding systems. Additionally, the parts resting inside the parts hopper under the weight of several other parts endure further stresses and in some instances, are permanently deformed. Using prior art systems on sensitive parts may result in a high percentage of defective or unworkable parts. Unfortunately, prior art systems cannot operate without the use of the parts hopper and the conveyor belt to bring the parts within the envelope of the robot.

Similarly, U.S. Pat. No. 4,790,709 to Sakimori et al. discloses a parts feeding system using a conveyor belt and a lifter to move parts to an envelope of a robot. In the '709 patent, the conveyor belt moves three trays of parts stacked one on top of the other from a loading station to the lifter. The lifter grabs and lifts two trays, which in turn allows a bottom tray to continue along the conveyor belt to the envelope of the robot. There, a vision device scans the parts and relays a position for the parts to a control system. The robot then grabs each part based on the position relayed to the control system and moves the part from the tray to a workspace. Again, as previously described, the disadvantages of such prior art systems include the requirement of added equipment such as the conveyor belt and the lifter to move the parts into the envelope of the robot.

As a result, there is a need in the art to improve upon prior art parts feeding systems by providing a parts feeding system that eliminates the need for the conveyor belt and the parts hopper and instead relies on the fall range of motion available to the robot within the envelope. Prior art systems are not advantageous for smaller manufacturing facilities that do not have space and/or capital to invest in large parts feeding systems that utilize multiple components such as parts hoppers, conveyor belts, and lifting mechanisms.

### SUMMARY OF THE INVENTION AND ADVANTAGES

The present invention provides a parts feeding system for moving parts relative to a support plane. The parts feeding system includes a robot having a base disposed on the support plane and operable within an envelope having a limit extending at an acute angle relative to the support plane. First and second part support trays are stacked one above the other for supporting parts thereon in a stacked position. The second part support tray is movable to a stored position uncovering the first part support tray immediately therebelow. Each of the part support trays have a front edge facing toward the base in the stacked position wherein the front edge of each of the part support trays is disposed a greater distance from the base than the part support tray therebelow to define a receding stacked relationship.

A method for moving the parts from the first and second part support trays using the robot is also provided. The method includes loading the first part support tray with the parts and moving the second part support tray from the stored position to the stacked position such that the second part support tray is supported by the parts on the first part support tray. The front edges of each of the first and second part support trays are positioned along a line disposed at the acute angle relative to the support plane when moving the second part support tray to the stacked position to define the recessed stack relationship between the first and second part support trays to maximize the number of the parts that can be reached by the robot. The second part support tray is loaded with the parts in response to the second part support tray being moved from the stored position to the stacked position. Once the first and second part support trays are loaded, the parts are unloaded from the second part support tray. The second part support tray is then moved from the stacked position to the stored position to uncover the parts on the first part support tray therebelow.

The parts feeding system and method of the present invention are advantageous over the prior art by providing a parts feeding system that is fully encompassed within the envelope of the robot such that the parts feeding system optimizes the envelope. The parts feeding system of the present invention eliminates the need for a conveyor belt to move parts from a parts hopper to the envelope. The parts feeding system of the present invention optimizes the envelope by using the receding stacked relationship of the part support trays. More importantly, such a parts feeding system is advantageous to smaller manufacturing facilities due to the reduction in cost and space requirements.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a perspective view of a parts feeding system of the present invention;

FIG. 2 is a perspective view of the parts feeding system illustrating the movement of a second part support tray between a stacked position and a stored position;

FIG. 3 is a perspective view of a parts feeding system illustrating an alternative embodiment of the present invention;

FIG. 4 is an side elevational view of the present invention illustrating a control system and vision device;

FIG. 5 is a partially cross-sectional view as taken along line 5-5 of FIG. 1 illustrating a tray system of the preferred embodiment;

FIG. 6 is a schematic view of a multi-station system illustrating a connection of a plurality of parts feeding systems to a server.

### DETAILED DESCRIPTION OF THE PREFERRED EMBODIMENT

Referring to the Figures, wherein like numerals indicate like or corresponding parts throughout the several views, a parts feeding system for moving parts 10 relative to a support plane 12 is generally shown at 14. The parts feeding system 14 utilizes a robot 16 having a base 18. The robot 16 is disposed on the support plane 12 to access the parts 10 that are stacked in a tray system 20.

As will be appreciated by those skilled in the art, the robot 16 is movable along six axes A1-A6 and operable within a work envelope 22, hereinafter referred to as the envelope 22. The envelope 22 defines the full range of motion of the robot 16 along the axes A1-A6. Hence, the robot 16 is limited in movement to the envelope 22. The envelope 22 has a limit 24 that extends at an acute angle B relative to the support plane 12, as illustrated in FIG. 4. The acute angle B is used merely for reference to define the limit 24 of the envelope 22 and is not intended to limit the present invention. It should be appreciated that the acute angle B can be measured from the support plane in any orientation, thus the measurement is not limited to being from the orientation of the limit 24, as shown. As will be appreciated by one skilled in the art, the envelope 22 is generally spherical in shape as illustrated in FIG. 4. The robot 16 interacts with the tray system 20 within the envelope 22. Hence, the robot 16 and the tray system 20 are operable within the envelope 22.

The tray system 20 supports the parts 10 to be moved by the robot 16. The robot 16 moves the parts 10 between the tray system 20 and a workspace 26 within the envelope 22 using a gripper 27 to grasp the parts 10. As will be appreciated by those skilled in the art, the gripper 27 may be any number of mechanisms used to move the parts 10. As shown herein, the gripper 27 comprises three expandable fingers that can be expanded and retracted to facilitate gripping of the parts 10. The gripper 27 may also be practiced using a single finger with magnetic attraction to move the parts, a claw-like gripper for grasping the parts, and the like. The workspace 26 can be defined as a parts storage area, a processing station, a grinding station, a welding station, and the like. The present invention is not concerned with processes carried out in the workspace 26, and as such this is not intended to limit the present invention.

Both the robot 16 and the tray system 20 are supported on the support plane 12. This includes configurations such as the robot 16 and the tray system 20 being supported on a table (not shown) which is supported by the support plane 12, i.e., support by the support plane 12 can be defined as support by a separate member supported by the support plane 12. The tray system 20 includes a plurality of part support trays 30 each of the same size and configuration and a tray support 32 engaging the part support trays 30 to position the part support trays 30 in a receding stacked relationship to one another. The receding stacked relationship is important for optimizing the envelope 22 of the robot 16. The tray support includes a pair of side panels 33 extending from a rear panel 35. The side panels 33 are generally triangular in shape to facilitate placing the part support trays 30 in the receding stacked relationship. Each of the part support trays 30 presents front and rear edges 34,36 being disposed along lines 38,40 disposed at the acute angle B relative to the support plane 12 in the receding stacked relationship. The receding stacked relationship refers to the part support trays 30 being staggered when stacked one above the other. The lines 38,40 are parallel to the limit 24 of the envelope 22 to further define the receding stacked relationship.

The tray system 20 optimizes the limit 24 of the envelope 22 of the robot 16 to maximize the number of the parts 10 that can be reached by the robot 16 in the envelope 22. Specifically, by having the front edges 34 of each of the part support trays 30 disposed along the line 38 at the acute angle B to the support plane 12 to define the receding stacked relationship, the number of the parts 10 that can be reached by the robot 16 is maximized.

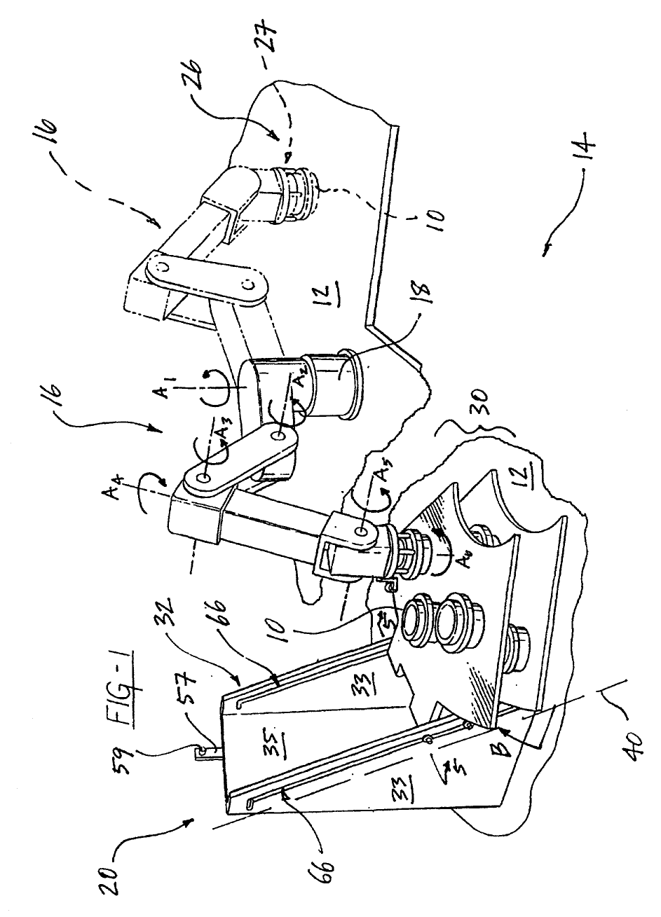

The front edges 34 of the part support trays 30 face toward the base 18 of the robot 16 when in a stacked position 48, as shown in FIG. 4. In FIG. 1, the front edges 34 of the part support trays 30 are oriented away from the base 18 of the robot 16. This is to illustrate that the tray system 20 and the parts feeding system 14 can also be utilized in alternative orientations. Referring again to FIG. 4, the front edge 34 of each of the part support trays 30 is disposed a greater distance from the base 18 than the part support tray 30 therebelow to define the receding stacked relationship. Referring to FIGS. 1-3, the front edge 34 of each of the part support trays 30 is arcuate. The arcuate configuration of the front edges 34 minimizes the obstruction to the robot 16 when the front edges 34 of the part support trays 30 are facing the base 18 of the robot 16. Such a configuration optimizes the envelope 22 without unnecessarily obstructing the robot 16. The rear edges 36 of the part support trays 30 are concentric with the front edges 34. The shape of the rear edges 36 mimics the spherical shape of the envelope 22, again to optimize the number of parts 10 that can be stacked on the tray system 20 while keeping the parts 10 within the envelope 22 of the robot 16. The part support trays 30 are all of the same size, but are not limited as such. The part support trays 30 can vary in size and configuration to the extent that the tray system 20 optimizes the envelope 22 of the robot 16. The tray system 20 can include several part support trays 30, but for descriptive purposes the tray system 20 will be generally discussed with reference to only first and second part support trays 42,44.

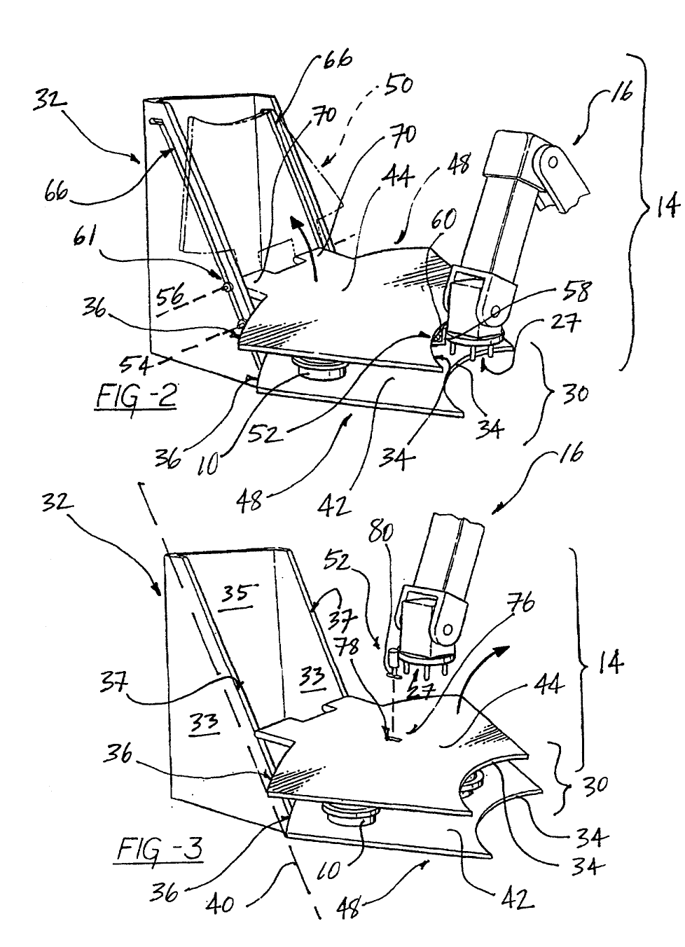

Referring to the embodiments of FIGS. 2 and 3, the first and second part support trays 42,44 are stacked one above the other for supporting parts 10 thereon when in the stacked position 48. The second part support tray 44 is movable to a stored position 50 uncovering the first part support tray 42 immediately therebelow. The robot 16 includes a tool 52 separate from the gripper 27 to move the second part support tray 44 between the stacked and stored positions 48,50. The gripper 27 could also be used as the tool 52 to move the second part support tray 44 between the stacked and stored positions 48,50. Hence, it is not required that the tool 52 be separate from the gripper 27. The first part support tray 42 may be fixedly connected to the tray support 32 such that the first part support tray 42 is not movable between the stacked and stored positions 48,50. However, in the embodiments described herein, both the first and second part support trays 42,44 are movable between the stacked and stored positions 48,50.

In the preferred embodiment of FIG. 2, the first and second part support trays 42,44 are rotatably supported on pivot axes 54,56 by the tray support 32 for rotational movement between the stacked and stored positions 48,50. A separate hinge 61 engages the tray support 32 and each of the first and second part support trays 42,44 to rotatably support the first and second part support trays 42,44 about the pivot axes 54,56 relative to the tray support 32 between the stacked and stored positions 48,50. The hinge 61 can be any mechanism that is well known in the art for rotatably connecting a member to a support.

The tray support 32 can include a bar 57 having a stopper 59, as shown in FIG. 1, to support the second part support tray 44 when in the stored position 50. The stopper 59 abuts a top surface of the second part support tray 44 when the second part support tray 44 is rotated from the stacked position 48 to the stored position 50. The tool 52 used by the robot 16 to move the first and second part support trays 42,44 between the stacked and stored positions 48,50 is further defined as a finger 58 having a roller 60. However, the particular tool used to move the first and second part support trays 42,44 is not limited to a finger 58 having a roller 60. Other tools such as a pincher, a magnet, a tool for rotating a lever connected to the hinge, and the like could also be used. FIG. 2 illustrates the robot 16 using the tool 52 to engage the second part support tray 44. The pivot axes 54,56 of the first and second part support trays 42,44 are disposed along a line 64 parallel to the limit 24. The side panels 33 of the tray support 32 define two slots 66 and the pivot axes 54,56 of the first and second part support trays 42,44 extend through the slots 66. One slot 66 could also be used. The slots 66 extends parallel to the limit 24. It should be appreciated that in alternative embodiments, the slots 66 can be curved and the pivot axes 54,56 can be disposed along a curved line defined by the slots 66 to mimic the spherical shape of the envelope 22 and further optimize the number of parts 10 that can be placed in the envelope 22. In this manner, the front and rear edges 34,36 can also be disposed along curved lines while defining the receding stacked relationship.

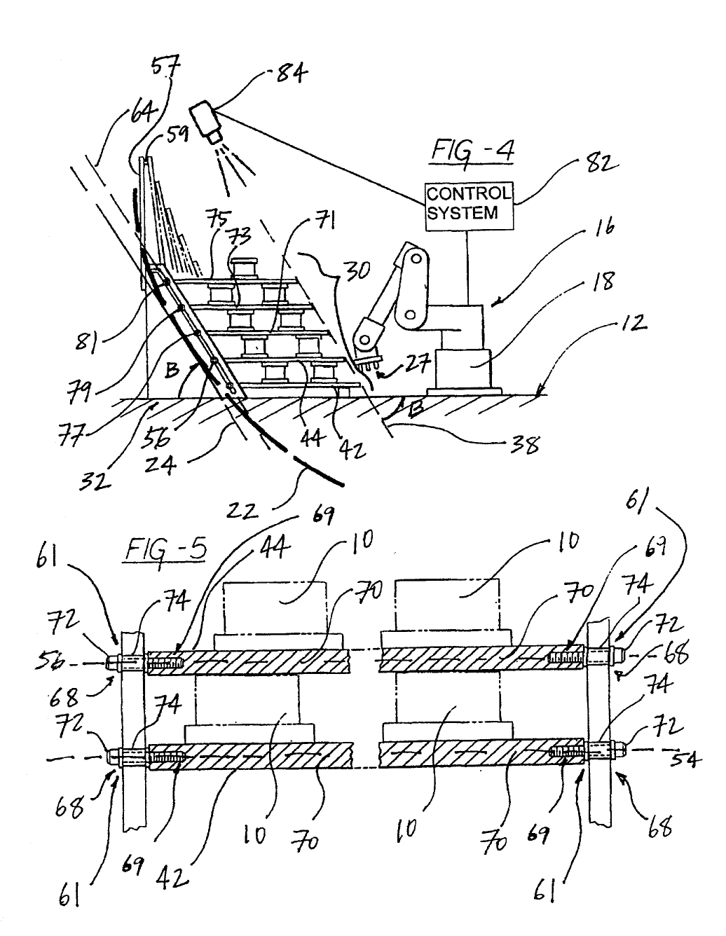

Referring to FIG. 5, an adjustment mechanism 68 adjusts the position of each of the pivot axes 54,56 along the slots 66 to vary the distance between the first and second part support trays 42,44 to accommodate different sizes of parts 10. Referring to FIG. 5, the adjustment mechanism 68 can also act as the hinge 61 to rotatably support the first and second part support trays 42,44 about the pivot axes 54,56 relative to the tray support 32. The adjustment mechanism 68 can be any mechanism that is well known in the art for adjustably connecting a member to a support.

The first and second part support trays 42,44 include arms 70 extending from the rear edge 36 to the pivot axis 54,56 such that the arms 70 are coupled to the tray support 32 by the adjustment mechanism 68. The adjustment mechanism 68 described herein includes two allen-head bolts 72 coupled to bushings 74 that extend through the slots 66. The allen-head bolts 72 are threadably connected to the arms 70 of the first and second part support trays 42,44 via threaded counterbores 69. The part support trays 42,44 are adjusted by sliding the pivot axis 56 along the slots 66 after partially unthreading the allen-head bolts 72 from the counterbores 69 thereby releasing the pressure between the tray support 32 and the bushings 74. The allen-head bolt 72 and bushing 74 act as both the hinge 61 and the adjustment mechanism 68.

The adjustment mechanism 68 could also be practiced using bushings positioned through counterbores defined in the arms 70 of the first and second part support trays 42,44. In this manner, bolts extends through the bushings and the slots 66 and are secured by lock nuts on outer surfaces of the tray support 32 adjacent the slots 66. The bushings rotatably supports the arms 70. Simply using a bolt extending through a counterbore in the arms 70 and through the slots 66 with a nut securing the bolt with the tray support 32 would also suffice. The adjustment mechanism 68 is not intended to limit the present invention.

Although the preferred embodiment discusses only first and second part support trays 42,44, the tray system 20 can also include additional part support trays 30 utilizing adjustment mechanisms 68 to rotate about the tray support 32. Specifically referring to FIG. 4, third, fourth, and fifth part support trays 71,73,75 are shown. Each being rotatably supported on a separate pivot axis 77,79,81 by the tray support 32. Each pivot axis 77,79,81 extending through the slot 66 and being disposed along the line 64 and at a greater distance from the base 18 than the pivot axis 77,79,81 of the part support tray 71,73,75 therebelow. Furthermore, the third, fourth, and fifth part support trays 71,73,75 include adjustment mechanisms 68 to adjust the position of the pivot axes 77,79,81 and the first, second, third, fourth, and fifth part support trays 42,44,71,73,75 further define the receding stacked relationship.

Referring to an alternative embodiment of FIG. 3, each of the side panels 33 of the tray support 32 have a front face 37 that engages the rear edge 36 of the first and second part support trays 42,44 to position the first and second part support trays 42,44 in the receding stacked relationship. In essence, the tray support 32 provides a frame of reference for the first and second part support trays 42,44. In alternative embodiments, the front faces 37 of the side panels 33 can be curved to further optimize the envelope 22 of the robot 16. In this manner, the front and rear edges 34,36 can also be disposed along curved lines while defining the receding stacked relationship. The second part support tray 44, in the alternative embodiment, defines a mechanical interconnecting mechanism 76 to allow the robot 16 to move the second part support tray 44 between the stacked position 48 and the stored position. In this embodiment, the stored position will be designated by an arrow 83 shown in FIG. 3. The arrow 83 illustrates movement from the stacked position 48 to the stored position 83. In the alternative embodiment, the second part support tray 44 is disengaged from the tray system 20 when moved from the stacked position 48 to the stored position 83, as shown in FIG. 3. Hence, the stored position 83 of the alternative embodiment is within the envelope 22, but separate from the tray support 32, as distinguished from the preferred embodiment. The stored position 83 can be a separate stack of part support trays on a table, a container for receiving the part support trays, a second tray system, and the like. The mechanical interconnecting mechanism 76 is further defined as the second part support tray 44 defining a receiving slot 78 for being engaged by the tool 52 to move the second part support tray 44 between the stacked and stored positions 48,83. The tool 52 of the alternative embodiment is further defined as a T-shaped bit 80. The T-shaped bit 80 extends through the receiving slot 78 and rotates to support the second part support tray 44. The robot 16 can then lift the second part support tray 44 with the T-shaped bit 80 and move the second part support tray 44 to the stored position 83. Again, the tray system 20 of the alternative embodiment is not limited to the first and second part support trays 42,44. Several additional part support trays 30 can be used to further define the receding stacked relationship. Each additional part support tray 30 being stacked on the parts 10 supported by the part support tray 30 therebelow.

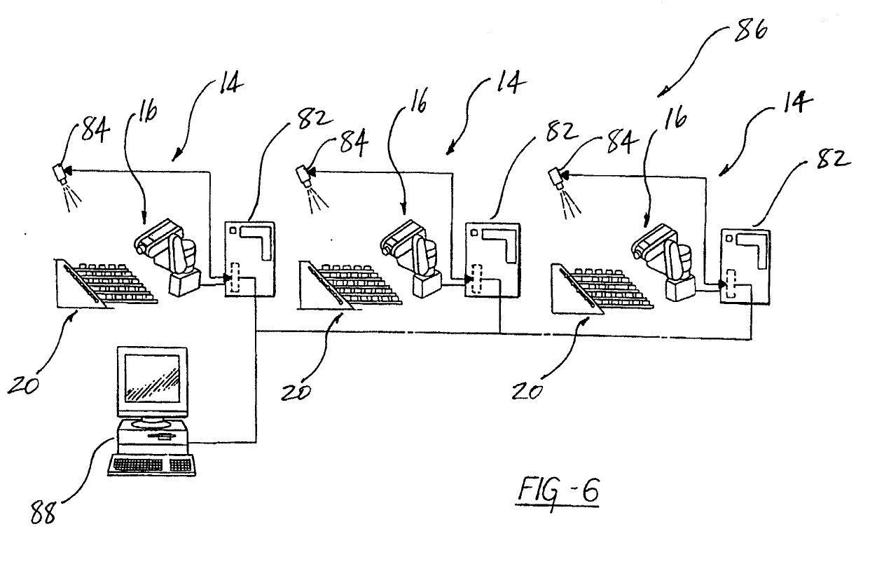

Referring to FIG. 4, for all embodiments, the present invention further includes a robot control system 82. The robot control system 82 controls movement of the robot 16. The robot control system 82 is well known in the art and is described for illustrative purposes only. A vision device 84 scans the parts 10 on the part support trays 30 to determine a position for each of the parts 10 and then relays a signal corresponding to the position to the robot control system 82. In turn, the robot control system 82 uses the position information from the signal of the vision device 84 to send a motion signal to the robot 16 and thus, control movement of the robot 16 to move the parts 10. The lines used in FIGS. 4 and 6 to connect the robot control system 82 to the robot 16 and the vision device 84 are schematic representation only and are not intended to represent structure.

FIG. 6 is schematic view of a multi-station system 86 illustrating a connection of a plurality of parts feeding systems 14 of the preferred embodiment to a server 88. Such a configuration supports centralized control of each of the parts feeding systems 14 to decrease part changeover times, efficiently calibrate the systems 14, and streamline operation. The multi-station system 86 could also be practiced using a plurality of parts feedings systems 14 of alternative embodiments.

The operation of the parts 10 feeding system is described below. The parts feeding system 14 is used to move the parts 10 from the part support trays 30 of the tray system 20 to the workspace 26. Prior to placing the tray system 20 in operation with the robot 16, the tray system 20 must be loaded with the parts 10.

The tray system 20 can be loaded using the robot 16, or an operator can load the tray system 20 manually. For illustrative purposes, manual loading by the operator shall be described. In sequence, the operator loads the first part support tray 42 with the parts 10 and moves the second part support tray 44 from the stored position 50 to the stacked position 48 such that the parts 10 on the first part support tray 42 support the second part support tray 44. Next, the operator loads the second part support tray 44 with the parts 10. This operation continues until all of the part support trays 30 have been loaded, as shown in FIG. 4. Thus, the tray system 20 is ready to be unloaded by the robot 16. For ease of description, only the steps carried out for the first and second part support trays 42,44 will be described.

Now that the tray system 20 is loaded and ready for use, the vision device 84 scans the parts 10 on the second part support tray 44 to determine the positions of the parts 10 on the second part support tray 44. The vision device 84 then transmits the signal to the robot control system 82 corresponding to the positions of the parts 10. The signal is interpreted by the robot control system 82 and the robot control system 82 sends the motion signal to control the movement of the robot 16 in response to the signal from the vision device 84. The robot 16 receives the motion signal from the robot control system 82 and proceeds to unload the parts 10 from the second part support tray 44, as illustrated in FIG. 1.

As described above, the robot 16 moves the parts 10 from the tray system 20 to the workspace 26, both inside the envelope 22 of the robot 16. (See FIG. 1). Once the parts 10 on the second part support tray 44 have been moved to the workspace 26, the second part support tray 44 is moved from the stacked position 48 to the stored position 50. The robot 16 uses the tool 52 to move the second part support tray 44 from the stacked position 48 to the stored position 50. In the preferred embodiment, the robot 16 uses the finger 58 and the roller 60 to rotate the second part support tray 44 about the pivot axis 56 to move the second part support tray 44 from the stacked position 48 to the stored position 50. In the alternative embodiment, the robot 16 inserts the tool 52 in the form of the T-shaped bit 80 through the receiving slot 78 in the second part support tray 44, rotates the T-shaped bit 80 to engage the second part support tray 44, and then lifts the second part support tray 44 from the stacked position 48 to move to the stored position 83. Independent of the manner of moving the second part support tray 44, once the second part support tray 44 is moved, the first part support tray 42 is scanned and unloaded.

The steps of scanning and unloading the parts 10 for the first part support tray 42 are similar to those for the second part support tray 44. The vision device 84 scans the parts 10 on the first part support tray 42 and transmits a second signal to the robot control system 82 corresponding to positions of the parts 10 on the first part support tray 42. It should be appreciated by one skilled in the art that any vision device 84 can be used to scan the parts. For instance, the vision device 84 may have the capability to scan the parts 10 while both the first and second part support trays 42,44 are in the stacked position 48, thus sending only one signal to the robot control system 82. Furthermore, the vision device may be mobile and moved across the parts 10 during scanning using a separate motion system or by the robot 16, or the vision device 84 may be fixed to a support. The vision device 84 can include a single camera or a plurality of cameras to scan the parts 10.

Irrespective of the vision device 84 employed, the robot control system 82 then sends a second motion signal to the robot 16 to control movement of the robot 16 in response to the vision device 84 scanning the parts 10 of the first part support tray 42. The robot 16 proceeds to unload the parts 10 from the first part support tray 42 after the vision device 84 has transmitted the second signal. The robot 16 moves the parts 10 from the first part support tray 42 of the tray system 20 to the workspace 26. It should be appreciated, that the robot 16 could also be used to load the tray system 20 by reversing the steps just described, i.e., loading the first part support tray 42 with the parts 10, moving the second part support tray 44 from the stored position 50 to the stacked position 48, and loading the second part support tray 44 with the parts 10.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

What is claimed is:

1. A parts feeding system for moving parts (10) relative to a support plane (12) comprising:
a robot (16) having a base (18) disposed on the support plane (12) and operable within an envelope (22),
a tray support (32) disposed in said envelope,
a first and a second part support tray (42,44) engaging said tray support (32), said first and second part support trays (42,44) stacked one above the other for supporting parts (10) thereon in a stacked position (48) and said second part support tray (44) movable to a stored position (50) uncovering said first part support tray (42) immediately therebelow,
said system characterized by said second part support tray (44) being rotatably supported on a pivot axis (56) by said tray support (32) for rotational movement between said stacked and stored positions (48,50).

2. The system as set forth in claim 2 wherein said part support trays (42,44) are all of the same size.

3. The system as set forth in claim 1 including a third part support tray (71) rotatably supported on a pivot axis (77) by said tray support (32), said first, second, and third part support trays being staggered to define a receding stacked relationship.

4. The system as set forth in claim 1 wherein said tray support (32) defines at least one slot (66) and said pivot axis (56) of said second part support tray (44) extends through said slot (66).

5. The system as set forth in claim 4 including an adjustment mechanism (68) for adjusting a position of said pivot axis (56) along said slot (66) for varying the distance between stacked part support trays (42,44) to accommodate different sizes of parts (10).

6. The system as set forth in claim 1 including a hinge (61) engaging said tray support (32) and said second part support tray (44) for rotatably supporting said second part support tray (44) relative to said tray support (32) between said stacked and stored positions (48,50).

7. A parts feeding system for moving parts (10) relative to a support plane (12), comprising:
a robot (16) having a base (18) disposed on the support plane (12) and operable within an envelope (22) having a limit (24) extending at an acute angle (B) relative to the support plane (12),
a first and a second part support tray (42,44) stacked one above the other for supporting parts (10) thereon in a stacked position (48) and said second part support tray (44) movable to a stored position (50) uncovering said first part support tray (42) immediately therebelow, each of said first and second part support trays (42,44) having a front edge (34)
said system characterized by said front edge (34) of each of said part support trays (42,44) being disposed a greater distance from said base (18) than the part support tray (42,44) therebelow for defining a receding stacked relationship.

8. The system as set forth in claim 7 wherein said front edges (34) of said first and second part support trays (42,44) face toward said base (18) in said stacked position (48).

9. The system as set forth in claim 8 wherein said front edges (34) of said part support trays (42,44) are disposed on a line (38) parallel to said limit (24).

10. The system as set forth in claim 9 wherein said part support trays (42,44) are all of the same size.

11. The system as set forth in claim 10 including a tray support (32) supporting said part support trays (42,44).

12. The system as set forth in claim 11 wherein said second part support tray (44) is rotatably supported on a pivot axis (56) by said tray support (32) for rotational movement between said stacked and stored positions (48,50).

13. The system as set forth in claim 12 including a third part support tray (71) rotatably supported on a pivot axis (77) by said tray support (32) wherein said pivot axis (77) of said third part support tray (71) is disposed a greater distance from said base (18) than said pivot axis (56) of said second part support tray (44) therebelow.

14. The system as set forth in claim 13 wherein said pivot axes (56,77) of said second and third part support trays (44,71) are disposed along a line (64) parallel to said limit (24).

15. The system as set forth in claim 14 wherein said tray support (32) defines at least one slot (66) and said pivot axes (56,77) of said second and third part support trays (44,71) extends through said slot (66), said slot (66) extending parallel to said limit (24).

16. The system as set forth in claim 15 including an adjustment mechanism (68) for adjusting a position of each of said pivot axes (56,71) along said slot (66) for varying the distance between stacked part support trays (42,44,71) to accommodate different sizes of parts (10).

17. The system as set forth in claim 10 wherein said front edge (34) of each of said part support trays (42,44) is arcuate.

18. The system as set forth in claim 17 wherein said part support trays (42,44) include a rear edge (36) concentric with said front edge (34) thereof.

19. The system as set forth in claim 18 wherein said rear edge (36) of each of said part support trays (42,44) is disposed along a line (40) parallel to said limit (24).

20. The system as set forth in claim 18 wherein said second part support tray (44) includes an arm (70) extending from said rear edge (36) to said pivot axis (56).

21. The system as set forth in claim 18 including a tray support (32) engaging said rear edge (36) of said part support trays (42,44) for positioning said part support trays (42,44) in said receding stacked relationship.

22. The system as set forth in claim 10 wherein said robot (16) includes a tool (52) for moving said second part support tray (44) between said stacked and stored positions (48,50).

23. The system as set forth in claim 22 wherein said second part support tray (44) defines a mechanical interconnecting mechanism (76) for allowing said robot (16) to move said second part support tray (44) between said stacked and stored positions (48,83).

24. The system as set forth in claim 23 wherein said mechanical interconnecting mechanism (76) is further defined as said second part support tray (44) defining a receiving slot (78) for being engaged by said tool (52) to move said second part support tray (44) between said stacked and stored positions (48,83).

25. The system as set forth in claim 7 including a robot control system (82) to control movement of said robot (16).

26. The system as set forth in claim 25 including a vision device (84) for scanning the parts (10) on the part support trays (42,44) to determine a position for each of the parts (10) and to relay the position to said robot control system (82) which in turn controls movement of said robot (16) to move the parts (10).

27. The system as set forth in claim 12 including a hinge (61) engaging said tray support (32) and said second part support tray (44) for rotatably supporting said second part support tray (44) relative to said tray support (32) between said stacked and stored positions (48,50).

28. A tray system (20) for supporting stacks of parts (10) to be moved by a robot (16) supported on a support plane (12) and operable within an envelope (22) having a limit (24), said system comprising:
a plurality of part support trays (30) each of the same size and configuration,
a tray support (32) engaging said part support trays (30) for positioning said part support trays (30) in a receding stacked relationship to one another.

29. The system as set forth in claim 28 wherein each of said part support trays (30) presents front and rear edges (34,36), said front edges (34) being disposed along a line (38) disposed at an acute angle (B) relative to said support plane (12) in said receding stacked relationship.

30. The system as set forth in claim 28 wherein at least one of said part support trays (30) is rotatably supported on a pivot axis (54,56,77,79,81) by said tray support (32) for rotational movement between stacked and stored positions (48,50).

31. The system as set forth in claim 30 wherein said tray support (32) defines at least one slot (66) and said pivot axis (54,56,77,79,81) of said at least one part support tray (30) extends through said slot (66), said slot (66) extending along a line (64) disposed at an acute angle (B) relative to said support plane (12).

32. The system as set forth in claim 29 wherein said front edge (34) of each of said part support trays (30) is arcuate.

33. The system as set forth in claim 32 wherein said part support trays (30) include a rear edge (36) concentric with said front edge (34) thereof.

34. The system as set forth in claim 29 wherein said tray support (32) engages said rear edges (36) of said part support trays (30) for positioning said part support trays (30) in said receding stacked relationship.

35. A method for moving parts (10) from first and second part support trays (42,44) having front edges (34) using a robot (16) disposed on a support plane (12) and operable within an envelope (22), the envelope (22) having a limit (24) extending at an acute angle (B) relative to the support plane (12), said method comprising the steps of:
loading the first part support tray (42) with the parts (10);
moving a second part support tray (44) from a stored position (50) to a stacked position (48), the second part support tray (44) being supported by the parts (10) on the first part support tray (42) when in the stacked position (48);
loading the second part support tray (44) with the parts (10) in response to the second part support tray (44) being moved from the stored position (50) to the stacked position (48);
unloading the parts (10) from the second part support tray (44) after the parts (10) have been loaded on the second part support tray (44);
moving the second part support tray (44) from the stacked position (48) to the stored position (50) after the parts (10) have been unloaded thereby uncovering the parts (10) on the first part support tray (42) therebelow;
said method characterized by positioning the front edge (34) of each of the first and second part support trays (42,44) along a line (38) disposed at the acute angle (B) relative to the support plane (12) when moving the second part support tray (44) to the stacked position (48) to define a recessed stack relationship between the first and second part support trays (42,44) when in the stacked position (48) to maximize the number of the parts (10) that can be reached by the robot (16).

36. The method as set forth in claim 35 including the step of engaging the second part support tray (44) with a tool (52) of the robot (16) to move the second part support tray (44) from the stacked position (48) to the stored position (50).

37. The method as set forth in claim 36 wherein the step of moving the second part support tray (44) from the stacked position (48) to the stored position (50) is further defined as rotating the second part support tray (44) about a pivot axis (56) to move the second part support tray (44) from the stacked position (48) to the stored position (50).

38. The method as set forth in claim 35 including the step of inserting a tool (52) of the robot (16) through a receiving slot (78) in the second part support tray (44) to move the second part support tray (44) from the stacked position (48) to the stored position (83).

39. The method as set forth in claim 38 including the step of lifting the second part support tray (44) with the tool (52) to move the second part support tray (44) from the stacked position (48) to the stored position (83).

40. The method as set forth in claim 35 including the step of scanning the parts (10) on the second part support tray (44) with a vision device (84) prior to unloading the parts (10) from the second part support tray (44) to determine the positions of the parts (10) on the second part support tray (44).

41. The method as set forth in claim 40 including the step of transmitting a signal from the vision device (84) to a robot control system (82) to control the movement of the robot (16) in response to scanning the parts (10) on the second part support tray (44).

42. The method as set forth in claim 41 wherein the step of unloading the parts (10) from the second part support tray (44) is further defined as moving the parts (10) from a tray system (20) within the envelope (22) to a workspace (26) within the envelope (22) wherein the parts (10) are manipulated by a process in the workspace (26).

43. The method as set forth in claim 42 including the step of scanning the parts (10) on the first part support tray (42) after moving the second part support tray (44) from the stacked position (48) to the stored position (50).

44. The method as set forth in claim 43 including the step of transmitting a second signal from the vision device (84) to the robot control system (82) to control movement of the robot (16) in response to scanning the parts (10) of the first part support tray (42).

45. The method as set forth in claim 44 including the step of unloading the parts (10) from the first part support tray (42) after transmitting the second signal from the vision device (84) to the robot control system (82).

46. The method as set forth in claim 45 wherein the step of unloading the parts (10) from the first part support tray (42) is further defined as moving the parts (10) from the tray system (20) to the workspace (26).
